(19) United States
(12) Patent Application Publication
(10) Pub. No.: US 2020/0308867 A1
(43) Pub. Date: Oct. 1, 2020

(54) MANUAL CONTROL DEVICE OF THE OPENING AND CLOSING OF THE LOCK OF A DOOR OR WINDOW

(71) Applicant: Pascal LECLERCQ, Brescia (IT)

(72) Inventor: Pascal LECLERCQ, Brescia (IT)

(21) Appl. No.: 16/761,484

(22) PCT Filed: Nov. 3, 2017
(86) PCT No.: PCT/IT2017/000241

§ 371 Date: May 4, 2020

(51) Int. Cl. E05B 3/04; E05B 15/00

(52) U.S. Cl. CPC E05B 3/04; E05B 2003/006; E05B 15/0053; E05B 15/0033

(57) ABSTRACT

The manual control device to open and close the lock of a door or window has a support body having a longitudinal cavity; a rotatable manual gripping member having a housing; a control rod engaged in the cavity of the support body; at least one quick blocking element of the axial extraction of the support body from the control rod, the support body having an end in the manual gripping member rigidly engaged in the housing and an end external of the gripping member. A support plate of the support body fixable to the door or window and having a hole to rotatably engage the external end of the support body. An angular position indexer of the manual gripping member, the indexer having a blocking seat and a one snap-fitting member engaged in the blocking seat, the blocking seat or snap-fitting member being formed integrally with the support body.

### CROSS REFERENCE TO RELATED APPLICATION

This is a U.S. National Phase Application under 35 U.S.C. § 371 of International Patent Application No. PCT/IT2017/000241, filed Nov. 3, 2017. The entire contents of which are hereby incorporated by reference.

### FIELD OF THE INVENTION

The present invention relates to a manual control device of the opening and closing of the lock of a door or window.

Handles for opening a door or window at present available on the market are generally pre-assembled with the handle support and with the handle follower.

### SUMMARY OF THE INVENTION

The pre-assembling of the handle, owing to the fact that it requires specific tools, can be delicate and not immediately achievable, at least whenever the necessary tools are not immediately available.

Sometimes, in order to fix some components to one another, mere human force is not sufficient and it becomes necessary to avail of tools that require a source of electrical energy in order to operate.

In this case the installer must be provided with the device already completely pre-assembled for the installation on the door or window.

The installer therefore has a pre-assembled finished product at hand, which leaves no space for customizing the finishings so as to satisfy the requirements of the final customer.

The control device can further provide special indexing means of the angular position of the handle.

Such indexing means in general comprise elastic elements which, by engaging in corresponding seats, generate a removable blocking of the rotation of the handle, providing a tactile perception of the carrying out of a certain operating condition, for example the opening, closing and fanlight opening conditions of a window.

Such indexing means are formed in general by autonomous blocks which are interposed between the handle support and the plate for fixing to the wall of the door or window.

Furthermore, such blocks have a specific construction which varies depending on the type of door or window.

The provision of indexing means therefore increases the number of components of the control device and complicates the management of the warehouse stocks as well as the process of pre-assembling.

The technical task of the present invention is, therefore, to provide a manual control device of the opening and closing of the lock of a door or window which obviates the above-described technical drawbacks of the prior art.

Within the scope of this technical task, an aim of the invention is to realize a manual control device of the opening and closing of the lock of a door or window of the type above described, which has general-purpose components in various possible applications.

A further aim of the invention is to realize a manual control device of the opening and closing of the lock of a door or window which can be assembled directly on the site of installation.

A further aim of the invention is to realize a manual control device of the opening and closing of the lock of a door or window which, given a same number of functions, has a smaller number of components.

A further aim of the invention is to realize a manual control device of the opening and closing of the lock of a door or window which guarantees the necessary fixing stability and a correct balancing of the supports to the control rod.

A further aim of the invention is to realize a manual control device of the opening and closing of the lock of a door or window which can be applied to the leaf of the door or window rapidly, simply, precisely and securely with an optimal blocking.

The technical task, as well as these and other objectives according to the present invention, are achieved by a manual control device of the opening and closing of the lock of a door or window, comprising a support body having a longitudinal cavity, a rotatable manual gripping member having a housing, a control rod engaged in said cavity of said support body, and at least one quick blocking element of the axial extraction of said support body from said control rod, said support body having an end internal of said manual gripping member, which end is rigidly engaged in said housing, and an end external of said manual gripping member, being further provided a support plate of said support body fixable to said door or window and provided with a hole in which said external end of said support body is rotatably engaged, and indexing means of the angular position of said manual gripping member, said indexing means comprising at least one blocking seat and at least one snap-fitting member engaged in said blocking seat, characterized in that said at least one blocking seat or said at least one snap-fitting member are formed integrally with said support body.

Said at least one snap-fitting member is preferably elastic or is biased by an elastic element. Said at least one blocking seat is preferably afforded in one-piece with said support body.

The hollow support body advantageously has an additional function, as by virtue of a special conformation, in cooperation with the support plate and without the aid of additional parts, it enables indexing the angular position of the manual gripping member.

The same functions can thus be carried out with a reduced number of components.

The device is consequently simpler, more reliable and compact and assembly thereof is more rapid.

Further, the same type of hollow support body can be used universally for indexing the angular position of the manual gripping member in combination with fixing plates of various types used in different applications, for example for both doors and windows.

The storage and transport logistics of the components can therefore be simplified.

At least one anti-extraction dowel of the manual gripping member from the support body is advantageously provided, which, as it can be applied by hand, enables assembly of the control device directly on the site of installation of the door or window.

The installer in this case can also receive the simple components and customize them with the finishings requested by the customer before proceeding to assembly.

Further, the control rod is advantageously friction-engaged with the quick blocking element and with at least one insert of said support body adapted to increase the force opposing the axial sliding of the control rod along said support body.

Providing the insert enables, on mounting the control device, the centering of the control rod between the support body and the right and left manual gripping member.

During the introduction in the first support body, the control rod, after having engaged the releasable quick blocking element present in the first support body, engages the insert present in the first support body so that the force opposing the further axial penetration of the control rod in the first support body increases. During the following introduction in the second support body, the control rod, after having engaged the releasable quick blocking element present in the second support body, continues with the axial penetration in the second support body as the force opposing the axial penetration in the second support body, initially due to only the quick blocking element present in the second support body, is lower than the force opposing the axial penetration in the first support body, due overall to the quick blocking element present in the first support body and the insert present in the first support body.

### DETAILED DESCRIPTION OF THE DRAWINGS

Further characteristics and advantages of the invention will be more evident from the description of preferred, but not exclusive, embodiments of the manual control device of the opening and closing of the lock of a door or window according to the invention, illustrated by way of indicative and non-limiting example in the accompanying drawings, in which:

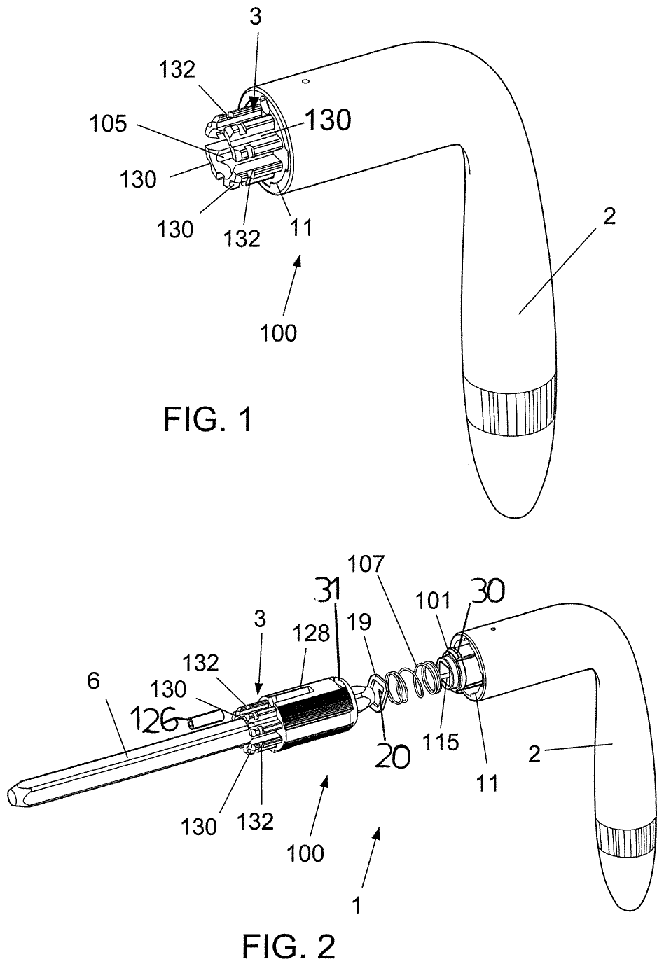

FIG. 1 shows one of the two identical parts of the control device, m an assembled configuration;

FIG. 2 shows one of the two identical parts of the control device, in an exploded configuration;

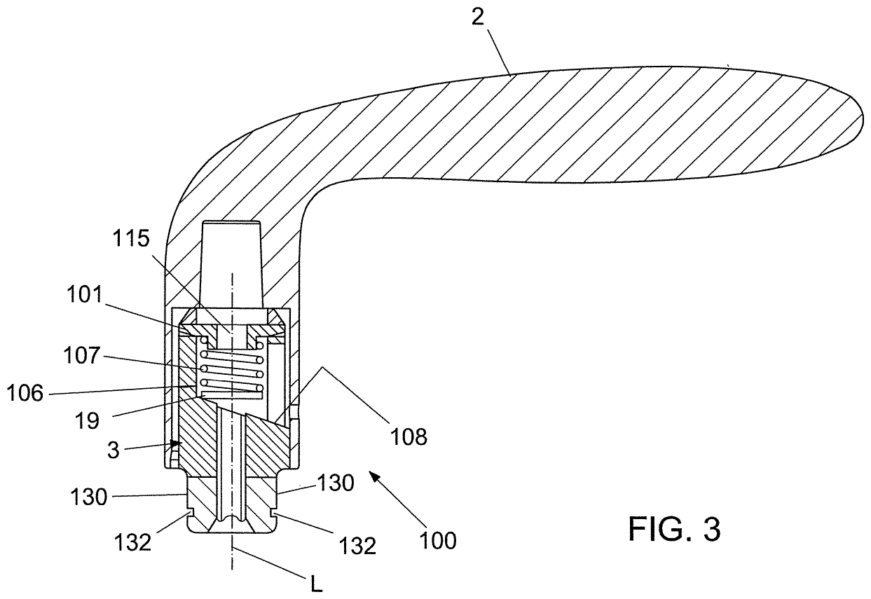

FIG. 3 shows the part of the control device of FIG. 1 sectioned with a plane containing the support axis;

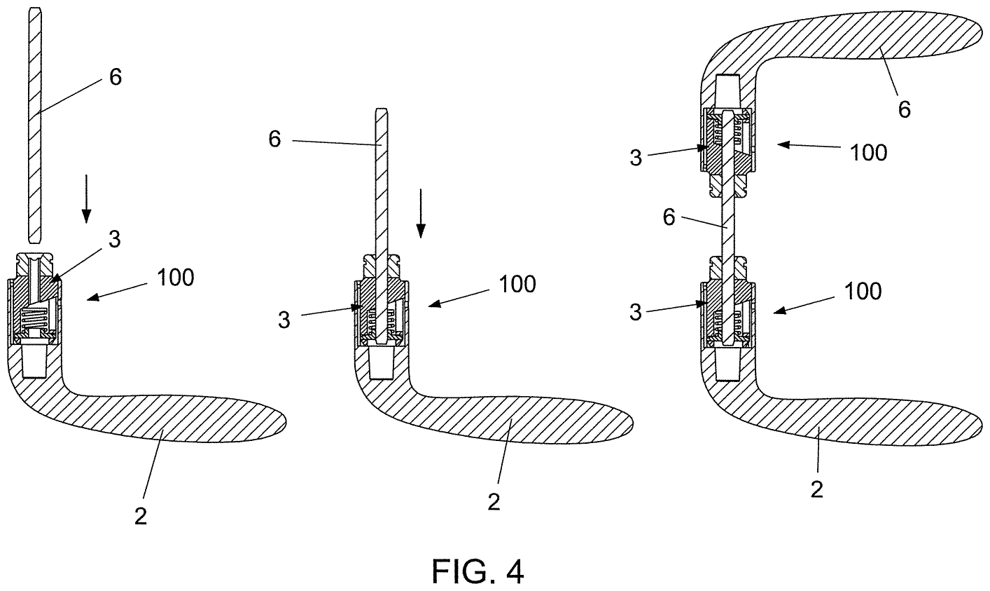

FIG. 4 shows the mounting sequence of the control device wherein the control rod is inserted first in the support body of the first part of the control device and subsequently in the support body of the second part of the control device;

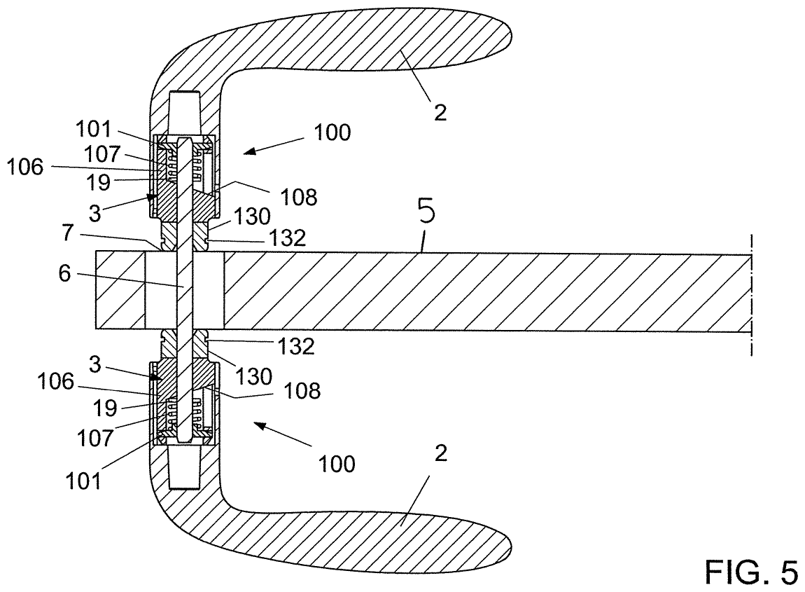

FIG. 5 shows the mounting configuration of the control device on a door having a slim thickness;

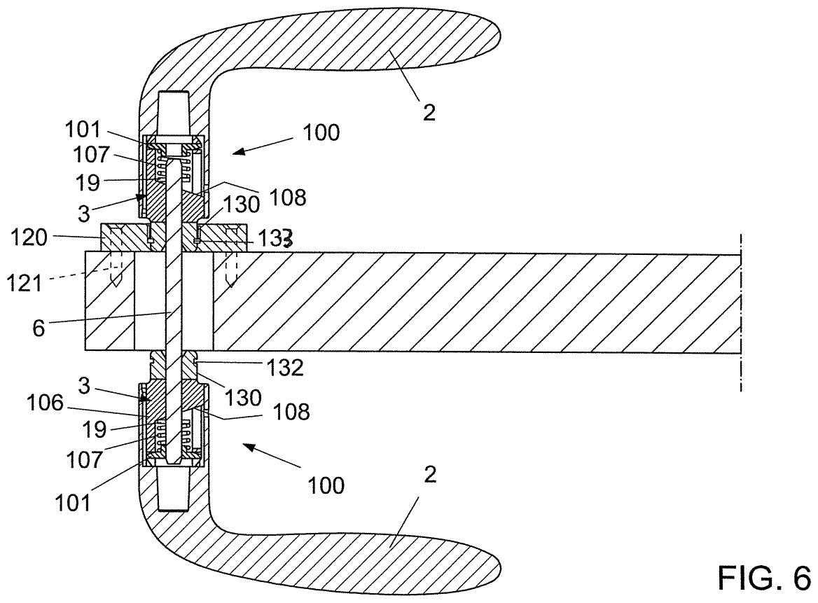

FIG. 6 shows the mounting configuration of the control device on a door having a large thickness;

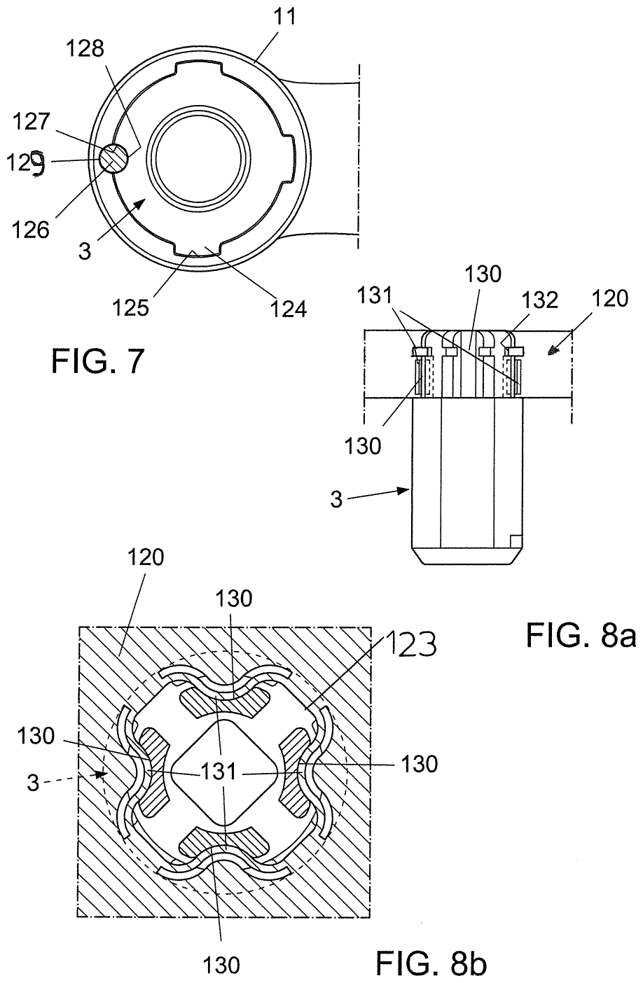

FIG. 7 frontally shows the support body inserted in the housing of the gripping member;

FIG. 8a and FIG. 8b are respectively a top and front views of the indexing means of the angular position of the manual gripping member.

### DETAILED DESCRIPTION OF THE DRAWINGS

The control device 1 comprises a control rod 6 or lock control follower (not shown) arranged through a transversal hole 7 of the leaf 5, and two identical parts 100, one engaged with the section of the control rod 6 projecting from the right side of the leaf 5 and the other one engaged with the section of the control rod 6 projecting from the left side of the leaf 5.

In any case the control device can also have a single part 100, where the actuation of the lock is requested only on one side of the leaf 5.

Reference will now be made to every single part 100.

The part 100 comprises a longitudinal support body 3 longitudinally having a cavity 105 through which the control rod 6 is arranged, a rotatable manual gripping member 2 having a housing 11, and at least one quick blocking element of the axial extraction of the support body 3 from the control rod 6.

The manual gripping member 2 can be, as shown, in the form of a handle or also a knob.

The quick blocking element comprises one or more laminated springs 19 stacked on one another. The support body 3 has an end internal of the manual gripping member 2 rigidly engaged in the housing 11 and an end external of the manual gripping member 2.

The cross section of the axial cavity 105 of the support body 3 has a shape matching with the cross section of the control rod 6.

The control rod 6 is friction-engaged with the laminated spring 19 and with an insert 101 of the support body 3 adapted to increase the force opposing the axial sliding of the control rod 6 along the cavity 105 of the support body 3.

The support body 3 has a compartment 106 in which the laminated spring 19 is housed, which laminated spring 19 is flexible in opposition to and by action of an elastic element 107, in particular a coil spring 107.

The compartment 106 is delimited by a front wall 108 that is inclined to the axis of the support body 3, and opens posteriorly of the support body 3 for introduction of the laminated spring 19, the coil spring 107 and the insert 101.

The laminated spring 19 has an internal port 20 having a shape matching with the cross section of the control rod 6. The laminated spring 19 is fixed at only one side thereof to the front wall 108 in order to be able to flex. The angle between the lie plane of the laminated spring 19 and the lie plane of the front wall 108 of the compartment 106 creates a space usable for accommodating the strain of the laminated spring 19 necessary for blocking and unblocking the control element 6 inserted through the internal port 20.

The insert 101 is fixed in the support body 3 and more precisely has peripheral fins 30 fitted in suitable through-openings 31 passing through the thickness of the side wall of the support body 3.

The insert 101 can preferably be made of rubber, for example silicone rubber, or other elastically-yielding material. The insert 101 has an axial hole 115 in which the control rod 6 can be inserted by friction sliding.

The insert 101 can also be made of a closed-cell foamed material.

To fix the manual gripping member 2 to the support body 3, two independent manual fixing systems are provided, one preventing the relative rotation between the parts and the other one preventing mutual extraction of the parts.

In particular, in order to prevent the relative rotation between the manual gripping member 2 and the support body 3, one or more anti-rotation members are provided, each formed by a protrusion 124 of the external surface of the support body 3 engaged in a complementarily-shaped recess 125 formed on the internal surface of the housing 11 or vice versa.

The control rod 6, the support body 3 and the manual gripping member 2 are thus integral in rotation about a rotation axis L.

In order to prevent the relative extraction between the manual gripping member 2 and the support body 3, one or more dowels 126 are provided, each engaged in a corresponding hole 127 delimited by matching grooves 128, 129 of the external surface of the support body 3 and the internal surface of the housing 11.

The two independent systems that cooperate for fixing the manual gripping member 2 to the support body 3 are both manual and thus enable carrying out the fixing operation directly on the site of installation, the installer receiving the disassembled simple components having the opportunity of carrying out the customized finishings before assembly.

The part 100 further provides a plate 120 for supporting the support body 3 fixed to the wall of the leaf 5, for example by means of screws 121.

The support plate 120 is provided with a hole 123 in which the external end of the support body 3 is rotatably engaged.

The external end of the support body 2 has an external peripheral groove 132 in which an anti-extraction elastic ring 133 is arranged to prevent extraction of the support body 3 from the hole 123 of the support plate 120.

The part 100 finally comprises indexing means of the angular position of the manual gripping member 2.

The indexing means comprise one or more blocking seats 130 and one or more snap-fitting members 131, each engageable by snap-fitting in a corresponding blocking seat 130. Each snap-fitting member 131 is elastic, or is in turn biased by an elastic element.

The blocking seats 130 or snap-fitting members 131 are advantageously formed integrally with the support body 3.

In particular, in the illustrated case, the blocking seats 130 are afforded in one-piece with the support body 3.

The blocking seats 130 are distributed along the external periphery of the external end of the support body 3, and more precisely are formed by variations in the thickness of the wall of the external end of the support body 3 which form depressions.

The blocking seats 130 are more precisely arranged symmetrically with respect to the axis of the support body 3 and are distributed in pairs that are diametrically aligned with respect to the axis of the support body 3.

The snap-fitting members 131 are arranged about the external end of the support body 3 and preferably, as shown, are distributed in pairs that are diametrically aligned with respect to the axis of the support body 3.

The snap-fitting members 131 are arranged and configured so as to slide along the external periphery of the external end of the support body 3 when the support body 3 is set in rotation.

The snap-fitting members 131 in the illustrated case are formed by leaf springs made in one-piece on the support plate 120.

Alternatively, to vary the elastic modulus, leaf springs can be chosen that are made of a different material and can be realized as separate elements that are then installed on the support plate 120. Therefore, during the rotation of the support body 3, each leaf spring is loaded when a depression rises and releases the elastic energy accumulated in the rise when it descends into the next depression.

The indexing means can have a number of variants, all falling within the scope of the invention.

For example, the snap-fitting members 131 and in particular the leaf springs can be formed integrally with the support body 3 and in this case the blocking seats 130 are provided on the support plate 120.

The snap-fitting members 131 can take on various forms, for example they can be balls arranged in special housings and movable in opposition to and by action of corresponding coil springs. In that case, during the rotation of the support body 3 each coil spring is loaded when the ball rises from a depression and releases the elastic energy accumulated in the rise when the ball descends into the next depression.

The mounting of the two parts 100 on the control rod 6, once the manual gripping member 2 has been fixed to the support body 3, takes place as follows.

The control rod 6 is inserted into the support body 3 of the first part 100. During the introduction the control rod 6, after having engaged the laminated spring 19, also engages the hole 115 of the insert 101 which increases the force opposing the further axial penetration of the control rod 6.

At this point the control rod 6 is inserted into the support body 3 of the second part 100, from the end opposite the end at which it is introduced into the support body 3 of the first part 100. During the introduction of the second part 100 into the support body 3, the control rod 6, after having engaged the laminated spring 19 present in the support body 3 of the second part 100, continues the axial penetration into the support body 3 of the second part 100 as the force opposing the axial penetration, due initially to only the laminated spring 19, is lower than the force opposing the further axial penetration of the control rod 6 in the support body 3 of the first pmi 100, due to both the laminated spring 19 and the insert 101 present in the support body 3 of the second part 100.

The selective introduction of the control rod 6 into the support body 3 of the second part 100 with respect to the first part 100, proceeds at least until the control rod 6 engages the hole 115 of the insert 101 present in the support body 3 of the second part 100.

This solution not only guarantees centering of the control rod 6 with respect to the two parts 100, but also enables use of the control device on doors or windows of different thicknesses, while using only one control rod 6.

Further, this solution very significantly simplifies the management logistics relating to warehouse stocks as the half-parts making up the control device are entirely identical, i.e. there is no distinction between the components necessary for the opening on the left side or the right side of the door or window.

The manual control device of the opening and closing of the lock of a door or window as herein conceived is susceptible to numerous modifications and variants, all falling within the scope of the inventive concept; furthermore, all the details are replaceable by technically equivalent elements.

In practice the materials used, as well as the dimensions, can be any according to the needs and the state of the art.

1. A manual control device of the opening and closing of the lock of a door or window, comprising:
a support body having a longitudinal cavity,
a rotatable manual gripping member having a housing,
a control rod engaged in said cavity of said support body, and
at least one quick blocking element of the axial extraction of said support body from said control rod,
wherein said support body having an end that is internal of said manual gripping member and rigidly engaged in said housing and an end that is external of said manual gripping member, a support plate of said support body being further provided, fixable to the door or window and provided with a hole in which said external end of said support body is rotatably engaged, and indexing means of the angular position of said manual gripping member, said indexing means comprising at least one blocking seat and at least one snap-fitting member engaged in said blocking seat, characterized in that said at least one blocking seat or said at least one snap-fitting member are formed integrally with said support body.

2. The manual control device of the opening and closing of the lock of a door or window according to claim 1, characterized in that said at least one snap-fitting member is elastic or is biased by an elastic element.

3. The manual control device of the opening and closing of the lock of a door or window according to claim 1, characterized in that said at least one blocking seat is afforded in one-piece with said support body.

4. The manual control device of the opening and closing of the lock of a door or window according to claim 3, characterized in that said blocking seats are distributed along the external periphery of said external end of said support body.

5. The manual control device of the opening and closing of the lock of a door or window according to claim 3, characterized in that said blocking seats are formed by variations in the wall thickness of said external end of said support body which form depressions.

6. The manual control device of the opening and closing of the lock of a door or window according to claim 3, characterized in that said blocking seats are arranged symmetrically with respect to the axis of said support body and are distributed in pairs that are diametrically aligned with respect to the axis of said support body.

7. The manual control device of the opening and closing of the lock of a door or window according to claim 2, characterized in that said elastic snap-fitting members are formed by leaf springs made in one-piece and/or installed on said support plate.

8. The manual control device of the opening and closing of the lock of a door or window according to claim 3, characterized in that said external end of said support body has an external peripheral groove in which an anti-extraction elastic ring is arranged to prevent extraction of said support body from said hole.

9. The manual control device of the opening and closing of the lock of a door or window according to claim 1, characterized in that it comprises at least one anti-extraction dowel of the manual gripping member from the support body, said anti-extraction dowel being engaged in a hole delimited by matching grooves of the external surface of said support body and the internal surface of said housing.

10. The manual control device of the opening and closing of the lock of a door or window according to claim 1, characterized in that it comprises at least one anti-rotation member which prevents relative rotation between said manual gripping member and said support body, said anti-rotation member being formed by a protrusion of the external surface of said support body engaged in a complementarily-shaped recess formed on the internal surface of said housing or vice versa.

11. The manual control device of the opening and closing of the lock of a door or window according to claim 1, characterized in that said control rod is frictionally engaged with said at least one quick blocking element and with at least one insert of said support body adapted to increase the force opposing the axial sliding of the control rod along said support body.

12. The manual control device of the opening and closing of the lock of a door or window according to claim 11, characterized in that said insert is made of rubber or a closed-cell foamed material.

13. The manual control device of the opening and closing of the lock of a door or window according to claim 12, characterized in that said insert has a hole in which said control rod is engageable by friction-sliding.

14. The manual control device of the opening and closing of the lock of a door or window according to claim 13, characterized in that said at least one quick blocking element comprises at least one laminated spring.
